(19) United States
(12) Patent Application Publication
(10) Pub. No.: US 2002/0007493 A1
(43) Pub. Date: Jan. 17, 2002

(54) PROVIDING ENHANCED CONTENT WITH BROADCAST VIDEO

(76) Inventors: LAURA J. BUTLER, SEATTLE, WA (US); GEORGE M. MOORE, REDMOND, WA (US)

Correspondence Address: LEE & HAYES PLLC, 421 W RIVERSIDE AVENUE SUITE 500, SPOKANE, WA, 99201

(21) Appl. No.: 08/902,005

(22) Filed: Jul. 29, 1997

(51) Int. Cl. H04N 7/173; H04N 5/445

(52) U.S. Cl. 725/109; 725/110; 725/37

(57) ABSTRACT

A video broadcast system includes a broadcast source that broadcasts a video stream and provides accompanying supplemental data files. Each supplemental data file is an HTML file having instructions for rendering a hyperlink overlay on the video stream. A receiver is configured to receive the video stream and accompanying supplemental data files and to display the hyperlink overlays in conjunction with the video stream. The overlays are designed having backgrounds of a pre-determined value which is used as a color key in receiving equipment. Specifically, the receiving equipment is configured to render video only in display areas that are set to the color key value. Thus, the video stream is rendered “behind” the hyperlink overlays, and the backgrounds of the overlays appears transparent. Control data is provided with the HTML files to indicate when the overlays should be rendered and to provide other instructions on how the HTML files should be handled by the receiving equipment.

### TECHNICAL FIELD

This invention relates methods and systems for providing and displaying ancillary data content with transmitted video and audio.

### BACKGROUND OF THE INVENTION

Displaying live video on a personal computer (PC) is becoming more and more common. A number of low cost video capture boards allow for display of analog video signals on the RGB display surface of a personal computer. Moreover, higher quality digital video feeds distributed, for example, via Direct Broadcast Satellite (DBS), will soon also be available on PCs. With the right hardware, PCs will be able to display and decode DBS signals, analog cable signals, and over-the-air-signals, as well as analog and digital video signals stored locally (on a CD or VCR, for example).

In the future, television signal decoder circuitry for both analog and digital signals will become extremely prevalent, if not standard, on all PCs. By enabling a user or viewer to work with, view, and use both data and video simultaneously, the PC will better the user's or viewer's experience beyond a standard television.

In this new broadcast environment, television broadcasters will want to take advantage of PC capabilities by providing digital program enhancements. For example, a broadcaster might want to provide ancillary statistics during a sports broadcast, allowing a viewer to find more detailed information on a particular team or player. Similarly, a broadcaster might provide relevant information on the topic of a documentary, so that the viewer can access more detailed information either during or after the broadcast. As another example, it might be desired to advertise program-related merchandise during a program—such as dolls or other toys during a children's cartoon program.

This method of delivering data to PCs is particularly attractive in areas of the world where there is not a great deal of traditional data infrastructure. For example, consider India which has a middle class population of about 300 million people (greater than the entire population of the US): while individuals can afford a PC and many do have PCs, few have experienced the Internet or high speed data networking, because of underdeveloped telecommunications infrastructure. The possibility of delivering data services to such locations presents a number of opportunities.

Recent years have also seen many efforts to develop what is referred to as “interactive television.” Interactive television allows a viewer to interact with a cable television service provider. Various enhanced features are envisioned for interactive television systems. For instance, interactive program guides can be implemented for viewers. Using an interactive program guide, a viewer can scroll through television listings using cursor control buttons on a remote control. A viewer can also perform interactive searches of program content. Some interactive TV systems have included the ability for broadcasters to provide ancillary data along with video feeds.

There has been no widespread acceptance of any interactive television system. One impediment to such widespread acceptance is that each system uses different standards and protocols for providing data that is ancillary to the primary video content. Unless a single system is instituted as a standard, broadcasters will have to provide ancillary data in numerous different formats. This is a significant impediment.

The invention removes this impediment by utilizing conventional formats for providing ancillary data along with video broadcasts, along with a scheme for overlaying digital data content on the primary video stream.

### SUMMARY OF THE INVENTION

The invention allows video broadcasters to prepare ancillary data content as HTML files. The HTML files are prepared as overlays, with backgrounds of a predetermined color key for viewing with video equipment having color keying features. At a receiver, the HTML overlays are rendered using typical Internet browser technology in the same display area as broadcast video, using color keying. This makes the overlay background appear transparent: the video appears only in the background areas of the HTML overlays.

### BRIEF DESCRIPTION OF THE DRAWINGS

FIG. 1 is a block diagram of a video broadcasting system in accordance with the invention.

FIG. 2 is a block diagram of an exemplary receiver in accordance with the invention.

FIG. 3 shows how video, HTML overlays, and frame windows are configured in accordance with the invention FIGS. 4 and 5 are flowcharts showing preferred methodological steps in accordance with the invention.

### DETAILED DESCRIPTION OF THE INVENTION

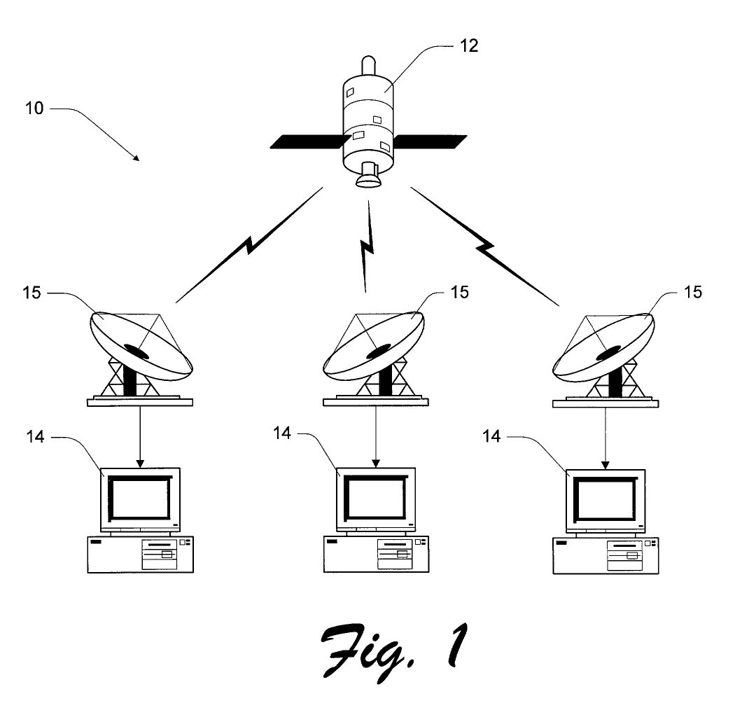

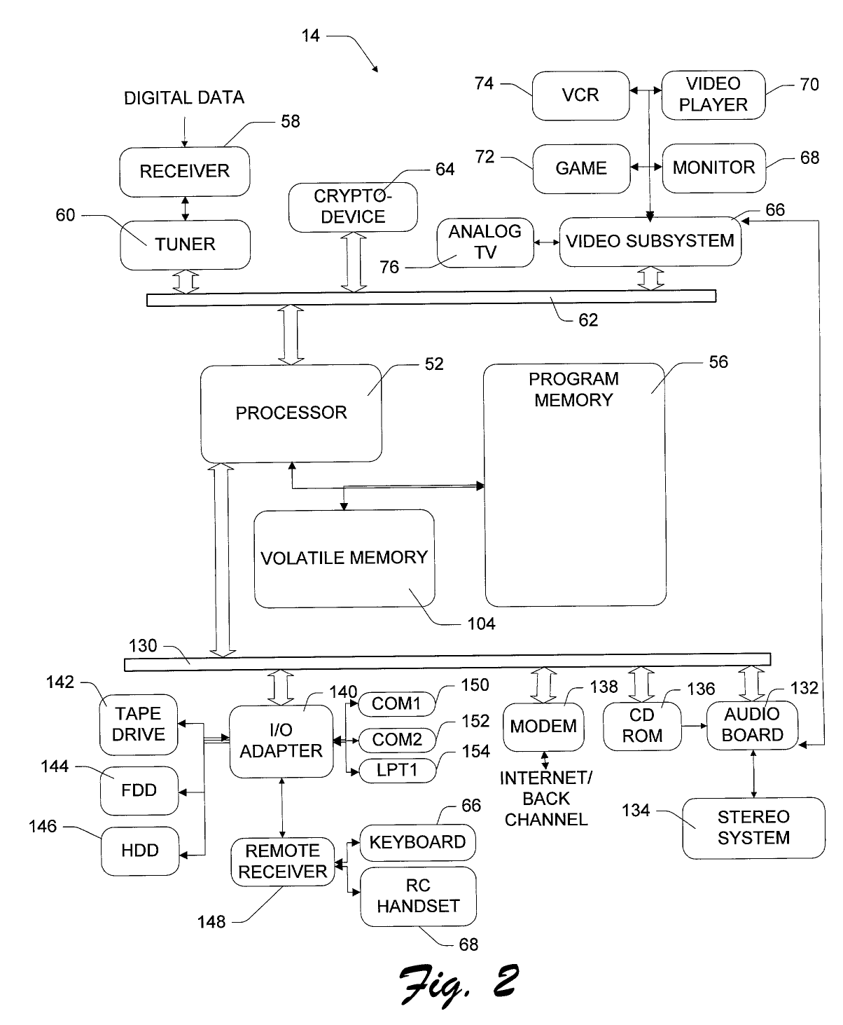

FIG. 1 shows a video broadcasting system in accordance with one embodiment of the invention, generally designated by reference numeral 10. Broadcasting system 10 includes a broadcast source 12 and a plurality of receivers 14. The broadcast source in this embodiment of the invention is a digital satellite system that broadcasts video content on multiple RF frequencies or channels. Alternatively, the broadcast source might be a traditional terrestrial television station and associated antenna, a cable system, or any analogous installation of equipment for transmitting video streams and accompanying data in analog or digital form.

In most instances, broadcast source 12 will support only uni-directional communications, and will be used predominately for unidirectional broadcasting or multi-casting to many receivers simultaneously without the receivers' foreknowledge. Broadcast source 12 might alternatively support bi-directional communication. Although only one broadcast source 12 is illustrated for explanation purposes, the broadcasting system can include multiple broadcast sources.

Broadcast source 12 includes means for transmitting or otherwise conveying a primary video stream and ancillary digital data content to receivers 14. In the case of digital satellite transmission, ancillary data can be easily transmitted in digital form along with video and audio streams. Protocols such as MPEG-2 already provide for incorporating ancillary digital data in packets that are downloaded with digital audio/video content using satellite transmission facilities. For example, existing DSS systems incorporate “hints” in MPEG streams to indicate aspect ratios for correct display by receivers. Another example is in the analog realm, in which Philips sells a device called the Ghost Echo Cancellation Reference Signal. By injecting a known digital stream on a single analog television VBI line, advanced televisions or PCs can more easily detect when a multipath (ghost) signal is received and take measures to clean up the image. There are about 800 TV stations in the US that implements this signal.

When using more traditional broadcast sources, such as analog RF television broadcasts, data can be transmitted in the vertical blanking interval of the television signal. This method is currently used to provide closed captioning for the hearing impaired. Digital data that has been transmitted in this way can be extracted from a television signal in a number of ways that are known in the industry—most currently-manufactured televisions have the capability of extracting and displaying closed captioning information. External closed caption decoders are also available for this purpose. Additionally, a number of external devices are available which extract closed caption data and transmit it over a serial cable to personal computers or other devices. More recently, it has become possible to decode closed captioning data directly inside a PC using newer video and video tuner boards that allow for a television signal to be displayed on a PC.

There are other mechanisms that are also available for transmitting digital data content to receivers 14. For example, it is possible to use a modem or other conventional network connection for digital data transmissions. Network connections such as these are independent of the traditional video transmission media, and have the advantage that they allow bi-directional communications between the broadcast source and the receivers. Communication facilities such as the Internet can also be utilized. Cable television networks might also provide similar communications capabilities. In addition, the newest plans for high-definition digital terrestrial TV define channels that are capable of transmitting 19.3 megabit/second of any amount of digital video or data.

It should be noted that the audio/video stream and the digital data content can be distributed using different media, respectively. While it is convenient to use only a single media such as over-the-air transmission, it would also be possible to distribute the digital data content using a physical medium such as a CD-ROM, while the video is delivered using traditional broadcasts. Alternatively, both video and data might in some cases be distributed using a physical, transportable medium such as a CD-ROM.

In the preferred embodiment of the invention, broadcast source 12 broadcasts an analog or digital video stream and provides supplemental digital data files to accompany the video stream. These data files have digital content that can be rendered by receivers 14, apart from the video stream. The broadcast source also provides timing specifications with the supplemental data files indicating times for displaying the digital content, relative to the video stream.

The digital content is preferably authored in a standard, commonly used graphical markup language. In the preferred embodiment of the invention, the supplemental data files are prepared and formatted in a current version of a Hypertext Markup Language (HTML). This allows broadcasters to use standard, widely accepted authoring tools such as used for authoring Internet World Wide Web content.

The supplemental digital data content preferably comprises one or more hyperlink overlays. Each hyperlink overlay includes one or more hyperlinks. A hyperlink is a displayed region or entity that can be selected or activated by a viewer. Each hyperlink has a target, indicating some other content (usually stored in a data file) that can be rendered for the viewer. When a hyperlink is activated, its target is retrieved and rendered. For example, if the target is a text document, the document is displayed. If the target is a file containing a digitized sound clip, the sound clip is rendered. The most common use of hyperlinks is to move or “navigate” from one document or object to another.

It will be apparent to those familiar with Internet technology that the hyperlink overlays described above are similar to documents (often referred to as “Web pages”) that can be viewed when browsing the Internet's World Wide Web. This is an attractive feature of the invention, because it allows broadcasters to use existing Internet content development tools for designing ancillary digital data content.

One difference from a conventional Web page is that a hyperlink overlay in accordance with the invention has a background that is set to a predetermined key color. Background areas, set to the key color, are intended to be transparent. A background such as this is easily created, again using standard Internet content development tools such as Microsoft's Front Page® web designer.

In this embodiment of the invention, receivers 14 are conventional personal computers (PCs) with equipment having display hardware for receiving and displaying broadcast video streams such as television signals and digital video broadcasts. The PC is also associated with a satellite dish 15 for receiving digital satellite broadcasts, or a regular antenna for receiving analog TV signals.

The display hardware includes bit-mapped graphics capabilities for displaying static bit-mapped images in conjunction with conventional application programs, in addition to video display capabilities. Furthermore, PCs 14 include video color keying hardware that can be configured to display video only in display areas that are set to a key color.

Alternatively, receivers 14 might comprise other types of devices such as enhanced television units having capabilities similar to the PC described herein.

As an example implementation, PC 14 is a personal computer having a processor (e.g., x86 or Pentium® microprocessor from Intel Corporation), memory, a computer monitor (e.g., VGA, SVGA), and one or more input devices (e.g., keyboard, mouse, etc.).

PC 14 has a digital receiver configured to receive digital broadcast data in a packetized format such as MPEG—encoded digital video and audio data. Such a digital receiver also has access means for reading supplemental data files received from satellite broadcasts—the receiver can receive digital data in many different forms, including software programs, programming information, and other ancillary data in the form of data files.

The PC runs an operating system that supports multiple applications. The operating system is preferably a multitasking operating system that allows simultaneous execution of multiple applications. The operating system employs a graphical user interface in a windowing environment which presents the applications or documents in specially delineated areas of the display screen called “windows.” One preferred operating system is a Windows® brand operating system sold by Microsoft Corporation, such as Windows 95 or Windows NT, Windows CE or other derivative versions of Windows®. It is noted, however, that other operating systems that provide windowing environments may be employed, such as the Macintosh operating system from Apple Computer, Inc. and the OS/2 operating system from IBM.

One example implementation of a broadcast-enabled PC is described in a co-pending U.S. patent application Ser. No. 08/503,055, entitled “Broadcast-Enabled Personal Computer,” filed Jan. 29, 1996. This application is assigned to Microsoft Corporation, and is incorporated herein by reference.

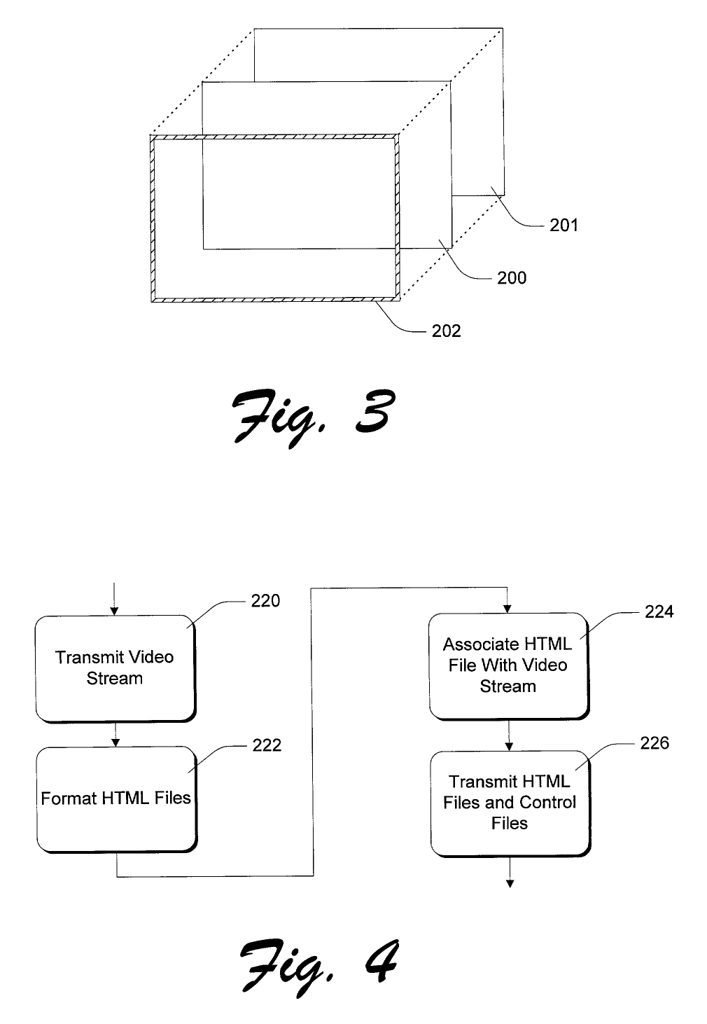

FIG. 2 shows an example implementation of PC 14 in more detail. PC 14 is enhanced for purposes of displaying broadcast television and accompanying digital data content. It includes a motherboard (not shown) having a processor 52 (e.g., x86 or Pentium® microprocessor from Intel Corporation) and volatile memory 54. Volatile memory 54, in combination with non-volatile memory 55, forms program storage memory 56. Non-volatile memory 55 comprises a floppy disk, a hard disk, a CD-ROM, or some other type of computer-readable storage media. Application programs, containing instructions for performing the steps described herein, are contained in the storage media.

PC 14 includes a digital broadcast receiver 58, such as a satellite dish receiver, RF receiver, microwave receiver, or the like. The digital receiver 58 receives digital data broadcast over a broadcast network such as a satellite network. The receiver 58 is coupled to a tuner 60 which tunes to frequencies or channels of the broadcast network. The tuner 60 has one or two primary components: a specialized digital broadcast tuner and/or a generalized digital broadcast tuner. The specialized digital broadcast tuner is configured to receive digital broadcast data in a particularized format, such as MPEG-encoded digital video and audio data. The generalized digital broadcast tuner is configured to receive digital data in many different forms, including software programs and other ancillary data.

The tuner 60 is connected to the motherboard and data processor 52 via a multi-bit bus 62, such as a 32-bit PCI (Peripheral Component Interconnect) bus. An optional cryptographic device 64 provides cryptographic services for the client, such as encryption, decryption, authentication, and digital signing.

The PC 14 has a video subsystem 66 connected to the PCI bus 62. Video and audio data is transferred from tuner 60 over PCI bus 62 to the video subsystem 66. In some embodiments, tuner hardware instead decodes an MPEG stream itself without ever passing the data over the PCI bus. In such systems, the uncompressed raw YUV video is sent along a simple wire connection to the video subsystem 66 board. In the illustrated embodiment, however, the video subsystem 66 includes circuitry for decoding MPEG-encoded or other video data formats. Video subsystem 66 also includes video display drivers for driving a computer monitor 68.

The video subsystem 66 supports many peripheral devices, in addition to the monitor 68. For instance, the video subsystem 66 might be connected to a laser video player 70 for playing DVD (digital video disks), a game machine 72 for playing video games, and a VCR (video cassette recorder) 74 for recording programs. The video subsystem 66 is adapted for connection to an analog broadcast television system 76 to receive conventional TV signals from cable television or RF broadcast television systems. This enables backwards compatibility to analog TV systems.

Video subsystem 66 also incorporates color keying features that aid in integrating video with static bit-mapped graphics. With color keying, an application program or the operating system configures the video subsystem to display a video stream in a rectangular area or “viewport” of monitor 68 in conjunction with whatever bit-mapped monitor image has been put in place by executing software. In effect, the video subsystem overwrites the normal bit-mapped display image with the video stream. However, the video subsystem is configured to overwrite only those areas of the bit-mapped display image that are set to a predetermined color or chroma key value. Thus, a bit-mapped image can be created having “transparent” areas or regions that are set to the color key value. The video stream will be displayed only in these transparent regions, so that the bit-mapped image will appear to overlay the video stream.

Tseng Labs, Cirrus Logic, Brooktree, ATI and S3 are examples of companies that manufacture video subsystems such as this.

Monitor 68 is preferably a VGA or SVGA monitor as is customary for personal computers, as opposed to a standard television. In the illustrated implementation, PC 14 does not convert the television-related data into an NTSC (National Television System Committee) format. Because of this, PC 14 is able to produce television data having superior quality when displayed on the VGA monitor. Other embodiments might convert images from VGA to NTSC for display on a standard TV screen, although they would have comparatively lower graphics resolution.

The PC 14 also includes a second bus 130, such as an ISA (Industry Standard Architecture) bus, coupled to the motherboard and data processor 52. An audio board 132 is coupled to the ISA bus 130 and serves as an interface with a number of audio output devices, such as conventional speakers. An amplifier may be coupled between the audio board and speakers if desired. The audio board is also coupled to the video subsystem 66 to receive decoded audio signals. The audio board 132 can be coupled to a stereo system 134, so that audio data can be output to the stereo system for enhanced sound and recorded. Newer computer systems might alternatively support sending digital audio streams outside the PC via a Universal Serial Bus or IEEE1394 connection to an external converter. This eliminates the need for an internal sound card and results in much higher fidelity audio.

A CD-ROM (or DVD) drive 136 is coupled to the ISA bus 130. The audio output produced by the CD ROM (or DVD) drive 136 is passed to the audio board 132.

PC 14 includes a modem 138, such as a 14.4 or 28.8 kbps fax/data modem, coupled to the ISA bus 130. The modem 138 is connected to a conventional telephone line and provides access to public networks, including the Internet. The modem 138 can be used to access and download data and supplemental content directly from an independent service provider. It can also be used to download supplemental data files originating from a broadcast source. Additionally, the modem 138 can be used for two-way communications with the broadcast source or another entity providing broadcast-related services.

An input/output (I/O) adapter 140 is coupled to the ISA bus 130 to interface with numerous I/O devices, including a digital tape driver 142, a floppy disk drive 144, and a hard disk driver 146. A remote receiver 148 is also coupled to the I/O adapter 140 for receiving signals from the remote cordless keyboard 66 and remote control handset 68 in an IR or RF format. Alternatively, the keyboard and handset can be directly wired to the computer. The I/O adapter 140 further provides conventional serial ports, including a COM1 port 150, a COM2 port 152, and an LPT1 port 154. An IR transmitter (not shown) can be coupled to the COM1 port 150 to generate infrared signals to control electronic devices, such as stereo equipment, VCR, and the like. The computer 60 can also be hooked directly to these components.

In accordance with the invention, PC 14 is programmed or configured to receive a digital video stream and accompanying HTML files from a broadcast source, and to display the video stream in conjunction with the hyperlink overlays defined by the HTML files.

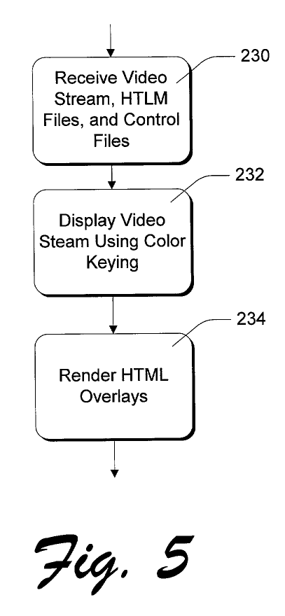

FIG. 3 shows how this is accomplished. An overlay window 200 is opened for displaying a hyperlink overlay. Video subsystem 66 is configured to display the video stream in a viewport 201 that coincides in size and position with the overlay window 200. The video subsystem is also configured to display the video stream only over those areas of the hyperlink overlay that are not set to the predetermined color key. Thus, non-transparent areas of the hyperlink overlay appear “through” the video stream, and appear to overlay the video stream. Perhaps the best example of this behavior is the TV weatherman who appears to “float” in front of a weather map. A frame window 202 is also utilized to define the edges of overlay window 200 and viewport 201. These three components are configured to appear as a single window to a user. Operating software is configured so that the user can resize and move the components as a single entity.

Overlay window 200 is preferably implemented using an ActiveX™ control that is designed specifically for displaying an HTML-formatted document. Such an ActiveX™ HTML control is configured to also allow browsing or navigating among documents by activating hyperlinks. ActiveX™ is a standard for interchangeable components that has been defined by Microsoft Corporation. ActiveX™ controls are display entities that allow a user or viewer to interact with programs through the display. In this case, the control displays an HTML-formatted document, allows the user to activate hyperlinks, and retrieves and displays the targets of such hyperlinks. A conventional HTML browser can alternatively be used for displaying the hyperlink overlays.

Rather than associating displayed icons with hyperlinks, it is also possible to create a totally transparent imagemask (using HTML terminology) to be overlaid on top of the video. This results in “hot spots” on the screen that can be clicked on for an action to occur. An example of this might be to create a hotspot on top of an actor's body; clicking on the hotspot would reveal what the character was thinking. Another example: a user could click on Tim Allen's Binford saw during an episode of “Tool Time” to find out more information about it such as where to purchase it.

Hyperlink overlays can be provided in groups corresponding to a particular video stream, allowing navigation among various individual overlays of the group. For example, a related group of overlays might be provided to a PC prior to the beginning of a particular episode of a weekly television show. The first of the overlays would be displayed at the beginning of the episode, and the viewer could then follow hyperlinks as desired to view the other overlays of the group.

Alternatively, timing and other information can be provided to the PC along with communication packets in which the overlays are transmitted. The timing information indicates times, relative to the video stream, at which particular overlays should be displayed. Hyperlinks can be activated to override the specified timing. An alternative method to synchronize the video that doesn't rely upon specific timing relative to the video stream is by using closed-caption text. By examining a closed-caption stream, specific events can be triggered to occur based upon when the actors on the screen enunciate certain words that serve as reference marks. Such technology is described in a co-pending US patent application Ser. No. 08/779,270, entitled “System and Method For Synchronizing Content With A Video Program Using Closed Captioning,” filed Jan. 6, 1997. This patent application, which is assigned to Microsoft Corporation, is hereby incorporated by reference.

PC 14 uses a stack-based algorithm to handle multiple overlays, so that one overlay can be temporarily overwritten by another. For example, an emergency news transmission might have overlays that would overwrite a regularly scheduled show. When the emergency news transmission is complete, the previous overlays are restored.

FIG. 4 shows preferred methodological steps performed by broadcast source 12 in accordance with the invention. A step 220 comprises transmitting a video stream. The video stream can be in one of a variety of formats, such as a traditional analog RF television format or a digital format originating from a satellite or a cable headend.

A step 222 comprises formatting supplemental data files in a graphical markup language, preferably HTML. Each supplemental HTML data file has instructions for rendering a hyperlink page or overlay on the video stream at an indicated time. Each overlay can have transparent areas or regions, which are set to a key color or chroma color. Overlays can also contain hyperlinks to other overlays and to other non-overlay documents and objects.

A step 224 comprises associating the supplemental data files with the video stream. This step is performing by specifying control data such as timing parameters along with the video stream, indicating times for displaying the hyperlink overlays in relation to the video stream. Note that supplemental files are sent prior to the time that they will be needed, taking data transmission speed into account.

Step 226 comprises transmitting the supplemental data files along with the video stream. As already discussed, this can be accomplished using the built-in capabilities of the digital transmission media or using the vertical blanking interval of a traditional analog television signal.

FIG. 5 shows steps performed by PC 14 or another receiver. A step 230 comprises receiving the video stream and accompanying supplemental from the broadcast source. Step 232 comprises displaying the video stream on a display device in a viewport using color keying technology, so that the video stream is actually displayed only on areas of the display that are set to a predetermined key color or chroma color.

A step 234 comprises displaying the hyperlink overlays, defined by the supplemental data files, on the display device in conjunction with the video stream. If the overlays have been previously cached, this step includes retrieving them from cache storage. Control data, received along with the supplemental data files, is used in this step to associate hyperlink pages or overlays with the video stream. As a result, overlays are displayed at the times indicated by the timing specifications contained in the control data, rather than at the time they are received.

In the default case, an ActiveX™ control is used to display the hyperlink overlays and to allow navigation using hyperlinks in the overlays. The ActiveX™ control is configured to occupy the same area as the video stream viewport. Thus, the video stream is rendered in the transparent areas of the hyperlink overlays. In some cases, PC 14 might actually create or render the ActiveX™ control ahead of time, although the control is not made visible until the appropriate time. This avoids any delay in presenting overlays.

Alternatively, control data might define multimedia objects that are not transparent hyperlink overlays. When this is the case, a separate application program is launched, such as an HTML-compatible browser, to render the object defined by a supplemental data file. Such an application program is launched in its own, independent window, and in the case of visually-oriented objects, can be viewed alongside the video stream.

As noted, control data, transmitted along with the supplemental data files, indicates how the supplemental data files should be handled. Primarily, the control data indicates times at which the data files should be rendered or made visible. In addition, the control data indicates what should happen when a viewer activates a hyperlink from within an overlay. Generally, activating a hyperlink causes its target to be displayed or otherwise rendered. However, there are two options when a hyperlink's target is another transparent overlay: the target can either replace the currently displayed overlay or the target can be displayed by an independent browser in a new window that is opened just for this purpose. If the hyperlink's target is not a transparent overlay, there is only one choice: the target is displayed in a new window by launching an appropriate application program. Step 234 thus includes a step of launching application programs as required to render non-overlay content targeted by hyperlinks.

In the PC embodiment described above, these steps are performed under the control of data processor 52, during execution of programming instructions that are stored in program memory 56.

While the invention has been described primarily for use with broadcast video streams, note that video streams might also be available through other means such as local storage (hard disk, DVD, CD, VCR, etc.). The invention is also useful in conjunction with video sources such as these. For instance, a movie might be provided on a DVD along with a group of transparent HTML overlay files for use along with the movie. Alternatively, the movie might be provided on a DVD, with the overlay files being downloaded from an Internet source.

Also note that even with broadcast sources, the transmission of supplemental data files does not have to take place concurrently with transmission of video streams. Rather, in some systems it might be desirable to broadcast overlay files during the night to user equipment, for use the following day. Control data indicates which programming the overlay files are to be associated with, and software at the user's PC retrieves the appropriate files at the appropriate times depending on the viewing selections of the user.

The invention provides an easy way for broadcasters and other video providers to supply supplemental textual and graphical materials, and to have such materials coordinated with video content. In contrast to prior systems, the invention takes advantage of widely-used hypertext authoring packages, as thus encouraging acceptance and standardization

In compliance with the statute, the invention has been described in language more or less specific as to structural and methodical features. It is to be understood, however, that the invention is not limited to the specific features described, since the means herein disclosed comprise preferred forms of putting the invention into effect. The invention is, therefore, claimed in any of its forms or modifications within the proper scope of the appended claims appropriately interpreted in accordance with the doctrine of equivalents.

1. A method comprising the following steps:
transmitting a video stream;
formatting supplemental data files in a graphical markup language, each supplemental data file having instructions for rendering a hyperlink overlay on the video stream;
transmitting the supplemental data files along with the video stream.

2. A method as recited in claim 1 wherein the formatting step comprises formatting the supplemental data files in HTML.

3. A method as recited in claim 1 and further comprising a step of transmitting timing specifications with the supplemental data files indicating times for displaying the hyperlink overlays.

4. A computer-readable storage medium having computer-executable instructions for performing steps as recited in claim 1.

5. A method as recited in claim 1 and further comprising the following additional steps:
receiving the video stream and accompanying supplemental data files;
displaying the hyperlink overlays in conjunction with the video stream.

6. A method as recited in claim 5, wherein the displaying step comprises launching an HTML-compatible browser to display the hyperlink overlays.

7. A method as recited in claim 5, wherein:
the formatting step comprises setting transparent areas of each hyperlink overlay to a key color;
the displaying step comprises displaying the video stream only in the areas of the hyperlink overlays that are set to a key color.

8. A method as recited in claim 5, wherein:
the formatting step comprises setting transparent areas of each hyperlink overlay to a key color;
the displaying step comprises launching an HTML-compatible browser to display the hyperlink overlays;
the displaying step further comprises displaying the video stream only in the areas of the hyperlink overlays that are set to a key color.

9. A method as recited in claim 5, wherein:
the formatting step comprises setting transparent areas of the hyperlink overlay to a key color;
the displaying step comprises displaying the hyperlink overlay and using color keying video hardware that displays video only in display areas that are set to a key color.

10. A method as recited in claim 5, wherein:
the formatting step comprises setting transparent areas of the hyperlink overlay to a key color;
the displaying step comprises launching an HTML-compatible browser to display the hyperlink overlays;
the displaying step further comprises using color keying video hardware that displays video only in display areas that are set to a key color.

11. A method as recited in claim 5, wherein the formatting step comprises including hyperlinks in the hyperlink overlays, the method further comprising an additional step of displaying content targeted by such hyperlinks in response to selecting such hyperlinks.

12. A method as recited in claim 5, wherein the formatting step comprises including hyperlinks in the hyperlink overlays, the method further comprising an additional step of replacing any currently displayed hyperlink overlay with content targeted by such hyperlinks in response to selecting such hyperlinks.

13. A method as recited in claim 5, wherein the formatting step comprises including hyperlinks in the hyperlink overlays, the method further comprising an additional step of opening new viewing windows for displaying content targeted by such hyperlinks.

14. A method as recited in claim 5, wherein the formatting step comprises including hyperlinks in the hyperlink overlays, the method further comprising an additional step of launching application programs as required to render content targeted by such hyperlinks.

15. A computer-readable storage medium having computer-executable instructions for performing steps as recited in claim 5.

16. A method comprising the following steps:
transmitting a video stream;
formatting HTML files having instructions for rendering hyperlink pages, the hyperlink pages having transparent areas that are set to a key color;
associating the HTML files with the video stream;
displaying the hyperlink pages on a display;
displaying the video stream on the display in areas of displayed hyperlink pages that are set to a key color.

17. A method as recited in claim 16, and further comprising the following additional steps:
transmitting timing specifications with the HTML files indicating times for displaying the hyperlink pages;
the step of displaying the hyperlink pages being performed at the times indicated by the timing specifications.

18. A method as recited in claim 16, wherein the step of displaying the hyperlink pages comprises launching an HTML-compatible browser.

19. A method as recited in claim 16, wherein the step of displaying the video stream comprises using color keying video hardware that displays video only in display areas that are set to a key color.

20. A method as recited in claim 16, further comprising an additional step of displaying content targeted by hyperlinks in response to selecting such hyperlinks.

21. A method as recited in claim 16, further comprising an additional step of replacing any currently displayed hyperlink pages with content targeted by hyperlinks in response to selecting such hyperlinks.

22. A method as recited in claim 16, the method further comprising an additional step of opening new viewing windows for displaying content targeted by hyperlinks in displayed hyperlink pages.

23. A method as recited in claim 16, further comprising an additional step of launching application programs as required to render content targeted by hyperlinks in displayed hyperlink pages.

24. A method comprising the following steps:
receiving a video stream;
associating one or more hyperlink pages with the video stream, the hyperlink pages having transparent areas that are set to a key color;
displaying the hyperlink pages on a display;
displaying the video stream on the display in areas of displayed hyperlink pages that are set to a key color.

25. A method as recited in claim 24, wherein the step of displaying the hyperlink pages comprises launching an HTML-compatible browser.

26. A method as recited in claim 24, wherein the step of displaying the video stream comprises using color keying video hardware that is configured to display video only in display areas that are set to a key color.

27. A method as recited in claim 24, wherein:
the step of displaying the hyperlink pages comprises launching an HTML-compatible browser;
the step of displaying the video stream comprises using color keying video hardware that is configured to display video only in display areas that are set to a key color.

28. A method as recited in claim 24, further comprising an additional step of displaying content targeted by hyperlinks in response to selecting such hyperlinks.

29. A method as recited in claim 24, further comprising an additional step of replacing any currently displayed hyperlink pages with content targeted by hyperlinks in response to selecting such hyperlinks.

30. A method as recited in claim 24, the method further comprising an additional step of opening new viewing windows for displaying content targeted by hyperlinks in displayed hyperlink pages.

31. A method as recited in claim 24, further comprising an additional step of launching application programs as required to render content targeted by hyperlinks in displayed hyperlink pages.

32. A computer-readable storage medium having computer-executable instructions for performing steps comprising:
receiving a video stream;
associating one or more hyperlink pages with the video stream, the hyperlink pages having transparent areas that are set to a key color;
displaying the hyperlink pages on a display;
displaying the video stream on the display in areas of displayed hyperlink pages that are set to a key color.

33. A computer-readable storage medium as recited in claim 32, wherein the step of displaying the hyperlink pages comprises launching an HTML-compatible browser.

34. A computer-readable storage medium as recited in claim 32, wherein the step of displaying the video stream comprises using color keying video hardware that is configured to display video only in display areas that are set to a key color.

35. A computer-readable storage medium as recited in claim 32, wherein:
the step of displaying the hyperlink pages comprises launching an HTML-compatible browser;
the step of displaying the video stream comprises using color keying video hardware that is configured to display video only in display areas that are set to a key color.

36. A computer-readable storage medium as recited in claim 32 having further computer-executable instructions for performing the additional step of displaying content targeted by hyperlinks in response to selecting such hyperlinks.

37. A computer-readable storage medium as recited in claim 32, having further computer-executable instructions for performing the additional step of replacing any currently displayed hyperlink pages with content targeted by hyperlinks in response to selecting such hyperlinks.

38. A computer-readable storage medium as recited in claim 32, having further computer-executable instructions for performing the additional step of opening new viewing windows for displaying content targeted by hyperlinks in displayed hyperlink pages.

39. A computer-readable storage medium as recited in claim 32, having further computer-executable instructions for performing the additional step of launching application programs as required to render content targeted by hyperlinks in displayed hyperlink pages.

40. A video broadcast system comprising:
a broadcast source that broadcasts a video stream and provides accompanying supplemental data files, each supplemental data file having instructions for rendering a hyperlink overlay on the video stream;
a receiver configured to receive the video stream and accompanying supplemental data files and to display the hyperlink overlays in conjunction with the video stream.

41. A video broadcast system as recited in claim 40, wherein the supplemental data files are formatted in HTML.

42. A video broadcast system as recited in claim 40, wherein the broadcast source provides timing specifications with the supplemental data files indicating times for displaying the hyperlink overlays relative to the video stream.

43. A video broadcast system as recited in claim 40, further comprising an HTML-compatible browser that the receiver launches to display the hyperlink overlays.

44. A video broadcast system as recited in claim 40, wherein the receiver comprises color keying hardware that displays video only in display areas that are set to a key color, the hyperlink overlays having transparent areas that are set to a key color.

45. A receiver for receiving and displaying video streams, comprising:
display hardware for displaying video streams and bit-mapped images to a user;
the display hardware including color keying hardware that displays video in display areas that are set to a key color;
access means for reading supplemental data files that have instructions for rendering bit-mapped hyperlink overlays in conjunction with the video stream at indicated times;
a data processor that reads the supplemental data files and in response displays the hyperlink overlays at the indicated times, wherein the hyperlink overlays have transparent areas that are set to a key color, the hyperlink overlays thus appearing to overlay the video streams.

46. A receiver as recited in claim 45, further comprising an HTML-compatible browser that the data processor executes to display the hyperlink overlays.

47. A receiver as recited in claim 45, wherein the data processor is programmed to display content targeted by hyperlinks in the hyperlink overlays in response to selecting such hyperlinks.

48. A receiver as recited in claim 45, wherein the data processor is programmed to replace any currently displayed hyperlink overlay with content targeted by a hyperlink in said currently displayed hyperlink overlay in response to selecting such hyperlink.

49. A receiver as recited in claim 45, wherein the data processor is programmed to open a new viewing window for displaying content targeted by a particular hyperlink in response to selecting the particular hyperlink.

50. A receiver as recited in claim 45, wherein the data processor is programmed to launch application programs as required to render content targeted by hyperlinks in hyperlink overlays.
